(19) United States
(12) Patent Application Publication
(10) Pub. No.: US 2019/0360616 A1
(43) Pub. Date: Nov. 28, 2019

(54) HIGH TEMPERATURE RESISTANT MULTILAYER TUBING

(71) Applicant: GM Global Technology Operations LLC, Detroit, MI (US)

(72) Inventor: Dennis M. D'hondt, Ray, MI (US)

(21) Appl. No.: 15/988,361

(22) Filed: May 24, 2018

(51) Int. Cl. F16L 11/08; F16L 11/12; B32B 1/08

(52) U.S. Cl. CPC F16L 11/081; F16L 11/127; B32B 1/08; F16L 11/125

(57) ABSTRACT

A multilayer plastic tubing for motor vehicles includes a first layer of tubing and a second layer of tubing positioned about the first layer of tubing. The first layer is stiffer and thinner than the second layer.

### INTRODUCTION

The present disclosure relates to multilayer tubing. More specifically, the present disclosure relates to multilayer tubing that is resistant to high temperatures.

Many types of hoses are in employed in motor vehicles. For some applications, the hose must withstand high temperatures and high pressures, such as in transmission oil cooler and engine oil cooler applications. In other applications, the hose must be resistance to degradation caused by chemicals when exposed to, for example, fuels. Regardless of the application, hoses are in general heavy and are not as amenable to tight bend radii for underhood packaging as thermoplastic tubing.

Thus, while current motor vehicle hoses achieve their intended purpose, there is a need for a new and improved tubing for the transmission of gases and liquids in various motor vehicle applications.

### SUMMARY

According to several aspects, a multilayer plastic tubing for motor vehicles includes a first layer of tubing and a second layer of tubing positioned about the first layer of tubing. The first layer is stiffer than the second layer and may be thinner than the second layer.

In an additional aspect of the present disclosure, the multilayer plastic tubing further includes a layer of adhesive positioned between the first layer of tubing and the second layer of tubing to adhere the first layer of tubing and the second layer of tubing together, if required.

In another aspect of the present disclosure, the adhesive is made of a modified polyolefin with functional groups.

In another aspect of the present disclosure, the first layer of tubing is made of a polyphenylene sulfide (PPS).

In another aspect of the present disclosure, the second layer of tubing is made of polyphthalamide (PPA).

In another aspect of the present disclosure, the multilayer plastic tubing is capable of operating at a maximum continuous temperature of about 180° C.

In another aspect of the present disclosure, the multilayer plastic tubing is capable of operating at a maximum continuous pressure of about 550 kPa.

In another aspect of the present disclosure, the second layer of tubing is made of a polyamide 612 (PA612).

In another aspect of the present disclosure, the multilayer plastic tubing is capable of operating at a maximum continuous pressure of about 275 kPa.

In another aspect of the present disclosure, the multilayer plastic tubing further includes a layer of conductive material positioned on the interior of the first layer of tubing.

In another aspect of the present disclosure, the layer of conductive material is made of polytetrafluoroethylene.

According to several aspects, a multilayer plastic tubing for motor vehicles includes a first layer of tubing made of PPS, a second layer of tubing positioned about the first layer of tubing, and a layer of adhesive positioned between the first layer of tubing and the second layer of tubing to adhere the first layer of tubing and the second layer of tubing together. The first layer of tubing is stiffer than the second layer of tubing and is thinner than the second layer of tubing.

In an additional aspect of the present disclosure, the adhesive is made of a modified polyolefin with functional groups.

In another aspect of the present disclosure, the second layer of tubing is made of polyphthalamide (PPA).

In another aspect of the present disclosure, the second layer of tubing is made of a polyamide 612 (PA612).

In another aspect of the present disclosure, the multilayer plastic tubing further includes a layer of conductive material positioned on the interior of the first layer of tubing.

In another aspect of the present disclosure, the layer of conductive material is made of polytetrafluoroethylene.

According to several aspects, a multilayer plastic tubing for motor vehicles includes a first layer of tubing made of PPS, a second layer of tubing positioned about the first layer of tubing, the second layer of tubing being made of PPA, and a layer of adhesive positioned between the first layer of tubing and the second layer of tubing to adhere the first layer of tubing and the second layer of tubing together. The first layer of tubing is stiffer than the second layer of tubing and is thinner than the second layer of tubing.

In an additional aspect of the present disclosure, the multilayer plastic tubing further includes a layer of conductive material positioned on the interior of the first layer of tubing, the layer of conductive material being made of polytetrafluoroethylene.

In another aspect of the present disclosure, the multilayer plastic tubing includes a layer of adhesive to bond the layer of conductive material to the first layer of tubing

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a cross-sectional view of a multilayer tubing in accordance with the principles of the present disclosure; and

FIG. 2 is a cross-sectional view of the multilayer tubing shown in FIG. 1 with an additional layer of a conductive material.

### DETAILED DESCRIPTION

The following description is merely exemplary in nature and is not intended to limit the present disclosure, application, or uses.

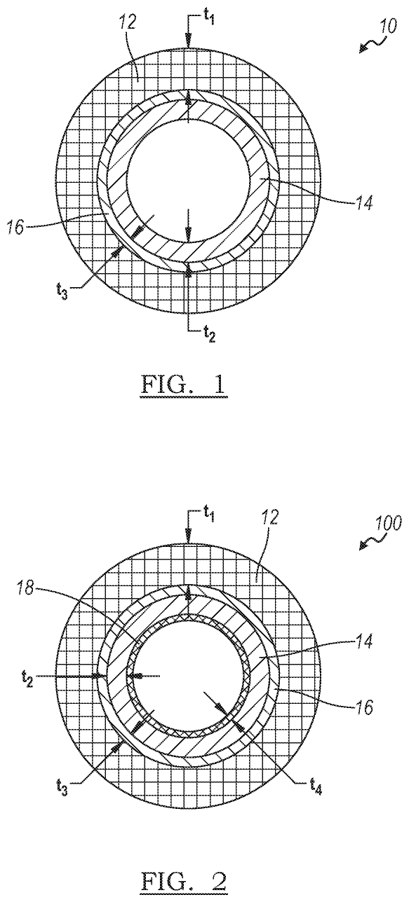

Referring to FIG. 1, there is shown a multilayer plastic tubing 10 for motor vehicle applications. The multilayer plastic tubing 10 includes a first layer of tubing 14 with a thickness t₂ positioned within a second layer of tubing 12 having a thickness t₁. Optionally a layer of adhesive 16 with a thickness t₃ may be utilized to adhere the first layer of tubing 14 and the second layer of tubing 12 together. The first layer of tubing 14 is stiffer than the second layer of tubing 12.

In a particular application, the first layer of tubing 14 and the second layer of tubing 12 have thicknesses between about 0.25 mm and 5 mm with the thickness t₂ of first layer of tubing 14 being less than the thickness t₁ of the second layer of tubing 12. The first layer of tubing 14 can be made from polyphyenylene sulfide (PPS) and the second layer of tubing 12 can be made from polyphthalamide (PPA). The thinness of the first layer of tubing 14 assures the flexibility of the multilayer plastic tubing 10 while the stiffness of the first layer of tubing maintains support for the multilayer plastic tubing 10 under conditions of pressurization or a vacuum at high temperatures. The multilayer plastic tubing 10 is configured for maximum continuous operating temperatures of about 180° C.

In general, the thickness t₃ of the adhesive layer 16 is thinner than both the thicknesses t₁ and t₂ of the first layer of tubing 14 and the second layer of tubing 12, respectively. In some applications the layer of adhesive 16 is made from, for example, a modified polyolefin with functional groups, or can be made from any other suitable material. The multilayer plastic tubing 10 is suitable for use in motor vehicle applications that experience high pressures of about, for example, 550 kPa and high temperatures of about, for example, 180° C., such as, for example, transmission oil cooler (TOC) application or engine oil cooler applications (EOC). In other applications, such as for example to transmit vapor gases which may experience pressures of about 200 kPa, the thicknesses of the first layer of tubing 14 and the second layer of tubing 12 are thinner than for TOC or EOC applications.

In other low pressure applications that are less demanding than TOC or EOC applications that experience pressures of, for example, 100 kPa to 275 kPa, the second layer of tubing 12 can be made from a polyamide 612 (PA612) rather than from PPA. The PA612 is also less robust at high temperatures than PPA. PA612, however, is cheaper than PPA. The PA612 can have a thickness between about 0.25 mm and 5 mm. The PA612 layer 12 is generally thicker than the PPS layer 14. Again, an optional layer of adhesive 16 may be employed to adhere the PA612 layer 12 and the PPS layer 14 together.

In certain applications of the multilayer plastic tubing 10, a layer of conductive material 18 (FIG. 2) can be positioned on the interior of the first layer of tubing 14, for example, when the tubing 10 is utilized for the transmission of liquid fuel. An optional layer of adhesive may be utilized to adhere layer of conductive material 18 to the first layer of tubing 14. The layer of conductive material 18 can be made from polytetrafluoroethylene (PTFE) and can have a thickness of about 0.1 mm. Note that such a conductive layer is not necessary for the transmission of fuel vapors.

In any of the above applications, the first layer of tubing 14 and the second layer of tubing 12 can be cut to length and then reheated in a forming fixture such that the multilayer plastic tubing 10 takes a specific configuration. To connect the multilayer plastic tubing 10 to the desired system, the ID of the multilayer plastic tubing 10 can be forced over barbs molded in the OD of a plastic fitting connected to the system. Alternatively, the multilayer plastic tubing 10 can be spin-welded onto the plastic fitting. More specifically, the ID of the multilayer plastic tubing 10 is placed over the OD of the plastic fitting forced over the plastic fitting until the end of the multilayer plastic tubing 10 abuts the connector body. The connector is then rotated rapidly until frictional forces melts the plastic surfaces. The cooling of the plastic creates a bond between the connector and the end of the multilayer plastic tubing 10. If the connector is made of metal, the tubing 10 is usually forced over an upset on the metal stem of the connector. If a quick-connector is utilized on the end of the multilayer plastic tubing 10, the port end (that is, the female end) of the connector snaps onto a plastic or metal tube with an end upset designed to lock into the port end.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A multilayer plastic tubing for motor vehicles comprising:
a first layer of tubing; and
a second layer of tubing positioned about the first layer of tubing,
wherein the first layer of tubing is stiffer than the second layer of tubing and is thinner than, thicker than or has the same thickness as the second layer of tubing.

2. The multilayer plastic tubing of claim 1 further comprising a layer of adhesive positioned between the first layer of tubing and the second layer of tubing to adhere the first layer of tubing and the second layer of tubing together.

3. The multilayer plastic tubing of claim 2 wherein the adhesive is made of a modified polyolefin with functional groups.

4. The multilayer plastic tubing of claim 1 wherein the first layer of tubing is made of a polyphenylene sulfide (PPS).

5. The multilayer plastic tubing of claim 4 wherein the second layer of tubing is made of polyphthalamide (PPA).

6. The multilayer plastic tubing of claim 5 wherein the multilayer plastic tubing is capable of operating at a maximum continuous temperature of about 180° C.

7. The multilayer plastic tubing of claim 5 wherein the multilayer plastic tubing is capable of operating at a maximum continuous pressure of about 550 kPa.

8. The multilayer plastic tubing of claim 4 wherein the second layer of tubing is made of a polyamide 612 (PA612).

9. The multilayer plastic tubing of claim 8 wherein the multilayer plastic tubing is capable of operating at a maximum continuous pressure of about 275 kPa.

10. The multilayer plastic tubing of claim 1 further comprising a layer of conductive material positioned on the interior of the first layer of tubing.

11. The multilayer plastic tubing of claim 10 wherein the layer of conductive material is made of polytetrafluoroethylene.

12. A multilayer plastic tubing for motor vehicles comprising:
a first layer of tubing made of PPS;
a second layer of tubing positioned about the first layer of tubing; and
a layer of adhesive positioned between the first layer of tubing and the second layer of tubing to adhere the first layer of tubing and the second layer of tubing together,
wherein the first layer of tubing is stiffer than the second layer of tubing and is thinner than the second layer of tubing.

13. The multilayer plastic tubing of claim 12 wherein the adhesive is made of a modified polyolefin with functional groups.

14. The multilayer plastic tubing of claim 12 wherein the second layer of tubing is made of polyphthalamide (PPA).

15. The multilayer plastic tubing of claim 12 wherein the second layer of tubing is made of a polyamide 612 (PA612).

16. The multilayer plastic tubing of claim 12 further comprising a layer of conductive material positioned on the interior of the first layer of tubing.

17. The multilayer plastic tubing of claim 16 wherein the layer of conductive material is made of polytetrafluoroethylene.

18. A multilayer plastic tubing for motor vehicles comprising:
a first layer of tubing made of PPS;
a second layer of tubing positioned about the first layer of tubing, the second layer of tubing being made of PPA; and
a layer of adhesive positioned between the first layer of tubing and the second layer of tubing to adhere the first layer of tubing and the second layer of tubing together,
wherein the first layer of tubing is stiffer than the second layer of tubing and is thinner than the second layer of tubing.

19. The multilayer plastic tubing of claim 18 further comprising a layer of conductive material positioned on the interior of the first layer of tubing, the layer of conductive material being made of polytetrafluoroethylene.

20. The multilayer plastic tubing of claim 19 further comprising a layer of adhesive to bond the layer of conductive material to the first layer of tubing.
